(19) United States
(12) Patent Application Publication
(10) Pub. No.: US 2016/0170249 A1
(43) Pub. Date: Jun. 16, 2016

(54) DISPLAY DEVICE AND DISPLAY PANEL

(71) Applicant: LG DISPLAY CO., LTD., Seoul (KR)

(72) Inventor: Dongjoo LEE, Goyang-si (KR)

(21) Appl. No.: 14/965,294

(22) Filed: Dec. 10, 2015

(30) Foreign Application Priority Data
Dec. 11, 2014 (KR) 10-2014-0178346

(51) Int. Cl. G02F 1/133; G02F 1/1339; G02F 1/1345

(52) U.S. Cl. CPC G02F 1/13306; G02F 1/13452; G02F 1/1339; G02F 2001/133357

(57) ABSTRACT

Disclosed are a display panel and a display device that have a small step difference in order to reduce possibility of occurrence of defects, such as damages or cracks, during a scribe process.

This application claims priority from and the benefit under 35 U.S.C. §119 (a) of Korean Patent Application No. 10-2014-0178346 filed on Dec. 11, 2014, which is hereby incorporated by reference for all purposes as if fully set forth herein.

### BACKGROUND OF THE INVENTION

1. Field of the Invention

The present invention relates to a display device and a display panel and a method of manufacturing the same.

2. Discussion of the Related Art

Liquid crystal display devices are continuously evolving and replacing the existing cathode-ray tubes (CRTs), and are being expanded into the DID (Digital Information Display) or PID (Public Information Display) market as display devices for laptops, computer monitors, TVs, and the like. Further, liquid crystal display devices are also keeping their position in the mobile market.

A liquid crystal display device is configured to display an image by regulating light transmittance of liquid crystal using an electric field. Liquid crystal display devices may be classified into a vertical electric field type or a horizontal electric field type.

In the vertical electric field-type liquid crystal display, a common electrode formed on an upper substrate and a pixel electrode formed on a lower substrate are disposed to face each other and a vertical electric field formed between the common electrode and the pixel electrode drives liquid crystal of a Twisted Nematic (hereinafter, referred to as “TN”) mode. Meanwhile, in the horizontal electric field-type liquid crystal display, a horizontal field formed between a pixel electrode and a common electrode disposed in parallel to each other on a lower substrate drives liquid crystal of an In Plane Switch (hereinafter, referred to as “IPS”) mode.

A liquid crystal display device includes a liquid crystal display panel including a TFT-array substrate including a thin film transistor (TFT), and the like, and a color filter substrate including a color filter, a black matrix, and the like which are bonded to each other, a spacer configured to uniformly maintain a cell gap between the bonded substrates, and a liquid crystal, and the like, filled in a space formed by the spacer.

On the TFT-array substrate and the color filter substrate of the liquid crystal display panel are various patterns, an insulating film, a flattening layer, and the like. Between the bonded two substrates are various components such as a liquid crystal layer and a sealant.

Even if there is a flattening layer, the liquid crystal display panel has a structure with a non-uniform thickness since various layers, patterns, and components are present in different manners depending on a location (region). In particular, the liquid crystal display panel has a structure with a large difference in thickness (step) between a pad area, in which a source driver integrated circuit, a flexible printed circuit, a metal signal wiring, and the like are disposed for signal transmission, and the other non-pad area.

Such a large step difference may cause difficulty in manufacturing or defects such as damage, cracks, and the like. For example, when a liquid crystal panel is manufactured, two substrates serving as a TFT-array substrate and a color filter substrate are bonded to each other, and then, a scribe process is performed to cut and separate the two bonded substrates into a plurality of liquid crystal display panels. While the scribe process is performed by moving a scribe wheel on the two bonded substrates having a large step difference, the scribe wheel may collide with an area where the large step difference starts, which may cause damage, such as a crack, in the two bonded substrates or the separated liquid crystal panels.

In other words, a liquid crystal display panel having a large step difference may cause difficulty in manufacturing and also defects such as damage, cracks, and the like during a manufacturing process such as a scribe process, thereby leading to low yield. This problem may also occur for other types of display panels such as an organic light emitting display panel.

### SUMMARY OF THE INVENTION

Accordingly, the present invention is directed to provide a display device and a display panel and a method of manufacturing the same that substantially obviate one or more problems due to limitations and disadvantages of the related art.

An advantage of the present invention is directed to provide a display device that has a small step difference.

Another advantage of the present invention is directed to provide a display panel and a display device that have a structure capable of reducing possibility of occurrence of defects, such as damages or cracks, during a scribe process.

Additional features and advantages of the invention will be set forth in the description which follows, and in part will be apparent from the description, or may be learned by practice of the invention. These and other advantages of the invention will be realized and attained by the structure particularly pointed out in the written description and claims hereof as well as the appended drawings.

To achieve these and other advantages and in accordance with the purpose of the present invention, as embodied and broadly described, a display device may, for example, include a display panel that includes a first substrate, a second substrate, and a flattening layer positioned on the first substrate and opened in an area where a sealant is present; a source driver integrated circuit attached to one side of the first substrate and electrically connected with data lines disposed on the first substrate; and a flexible printed circuit attached to one side of the first substrate and electrically connected with the source driver integrated circuit.

In another aspect of the present invention, a display panel may, for example, include a first substrate; a second substrate facing the first substrate; a sealant that bonds the first and second substrates; and a flattening layer positioned on the first substrate and opened in an area where the sealant is present.

In yet another aspect of the present invention, a display panel may, for example, include a first substrate; a second substrate facing the first substrate; a sealant that bonds the first and second substrates; and a flattening layer positioned on the first substrate and opened in an edge area including from an edge point of the first substrate to a point inwardly apart by a predetermined distance from the edge point.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a schematic system configuration view of a display device according to an exemplary embodiment of the present invention;

FIGS. 2 and 3 are plane views of a liquid crystal display device according to an exemplary embodiment of the present invention;

FIG. 4 is a cross-sectional view of a first case of a liquid crystal display device according to an exemplary embodiment of the present invention;

FIG. 5 is a cross-sectional view of a second case of a liquid crystal display device according to an exemplary embodiment of the present invention;

FIG. 6 is a diagram provided for comparing a difference in thickness (step) between the first case and the second case of the liquid crystal display devices according to an exemplary embodiment of the present invention;

FIG. 7 is a diagram provided for describing a scribe process when manufacturing a liquid crystal display panel according to an exemplary embodiment of the present invention;

FIG. 8 is a cross-sectional view illustrating a scribe process when manufacturing the first case of the liquid crystal display device according to an exemplary embodiment of the present invention;

FIG. 9 is a cross-sectional view illustrating a scribe process when manufacturing the second case of the liquid crystal display device according to an exemplary embodiment of the present invention; and

FIG. 10 is a graph showing a defect incidence rate during a scribe process when manufacturing each of the first case and the second case of the liquid crystal display devices according to an exemplary embodiment of the present invention.

### DETAILED DESCRIPTION OF THE ILLUSTRATED EMBODIMENTS

Exemplary embodiments of the present invention will now be described in detail with reference to the accompanying drawings. The same reference numbers will be used throughout the drawings to refer to the same or like parts. In the following description, a detailed explanation of known constructions and functions may be omitted to avoid unnecessarily obscuring the subject matter of exemplary embodiments of the present invention.

The terms, such as first, second, A, B, (a), (b) or the like may be used herein when describing components of the present invention. Each of these terminologies is not used to define an essence, order, sequence, the number of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

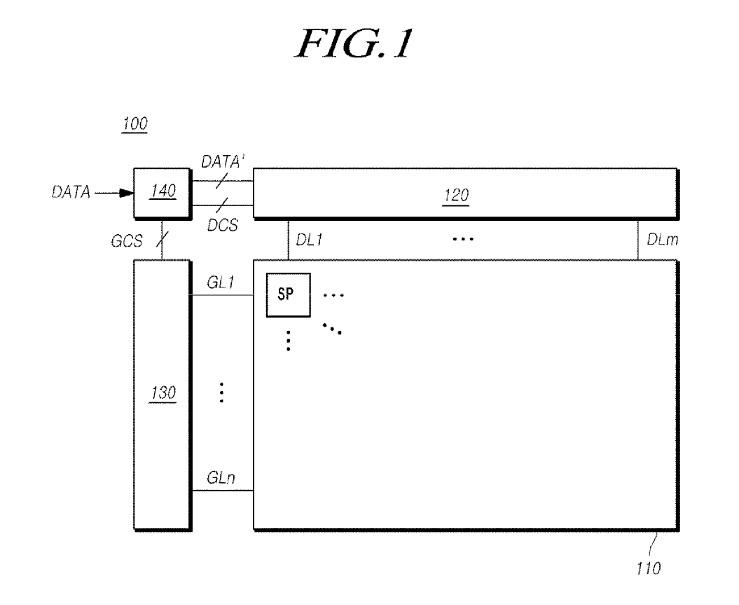

FIG. 1 is a schematic system configuration view of a display device 100 according to an exemplary embodiment of the present invention.

Referring to FIG. 1, the display device 100 according to an exemplary embodiment includes a display panel 110 in which m number of data lines DL1, . . . , DLm (m: natural number) and n number of gate lines GL1, . . . , GLn (n: natural number) are disposed, a data driving unit 120 configured to drive the m number of data lines DL1, . . . , DLm, a gate driving unit 130 configured to drive the n number of gate lines GL1, . . . , GLn in sequence, and a timing controller 140 configured to control the data driving unit 120 and the gate driving unit 130.

In the display panel 110, sub-pixels SP are defined by the crossing of the m number of data lines DL1, . . . , DLm and the n number of gate lines GL1, . . . , GLn.

The timing controller 140 starts scanning according to a timing realized in each frame, converts an image data Data input from a host system (not illustrated) into a data signal format used in the data driving unit 120, outputs the converted image data Data′, and controls data driving at an appropriate time according to the scanning.

The timing controller 140 may output various control signals such as a data control signal (DCS), a gate control signal (GCS), and the like in order to control the data driving unit 120 and the gate driving unit 130.

The gate driving unit 130 sequentially supplies a gate-on or gate-off voltage scan signal to the n number of gate lines GL1, . . . , GLn and sequentially drives the n number of gate lines GL1, . . . , GLn under the control of the timing controller 140.

The data driving unit 120 stores the input image data Data in a memory (not illustrated), and when a specific gate line is opened, the data driving unit 120 converts the corresponding image data Data′ into an analogue data voltage Vdata and supplies the converted data Vdata to the m number of data lines DL1, . . . , DLm so as to drive the m number of data lines DL1, . . . , DLm under the control of the timing controller 140.

The data driving unit 120 may include a plurality of source driver integrated circuits (Source Driver ICs, also referred to as Data Driver ICs).

The plurality of source driver ICs may be connected with a bonding pad of the display panel 110 by a TAB (Tape Automated Bonding) or COG (Chip on Glass) technology, or may be directly formed on the display panel 110. The plurality of source driver ICs may also be integrated on the display panel 110.

The gate driving unit 130 may be positioned on only one side of the display panel 110, as illustrated in FIG. 1, or may be separated into two units and positioned on both sides of the display panel 110, depending on the driving method.

Further, the gate driving unit 130 may include a plurality of gate driver integrated circuits (Gate Driver ICs).

The plurality of gate driver ICs may be connected with the bonding pad of the display panel 110 by a TAB (Tape Automated Bonding) or COG (Chip on Glass) technology, or may be realized into a GIP (Gate In Panel) type and directly formed on the display panel 110. The plurality of gate driver ICs may also be integrated on the display panel 110.

The display device 100 has a small step difference and can reduce occurrence of defects, such as damage or cracks, during the manufacturing process, such as a scribe process.

The display device 100 can be any type of a display device. As an example, the display device 100 may be one of a liquid crystal display device, an organic light emitting display device, a plasma display device, and the like.

For ease of explanation, the display device 100 and the display panel 110 will now be described as a liquid crystal display device and a liquid crystal display panel, respectively.

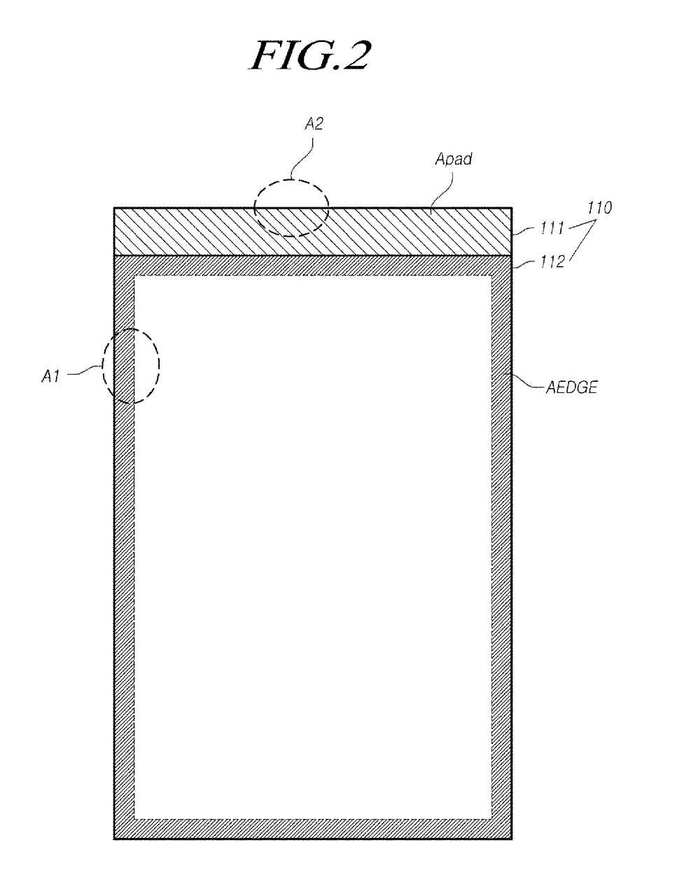

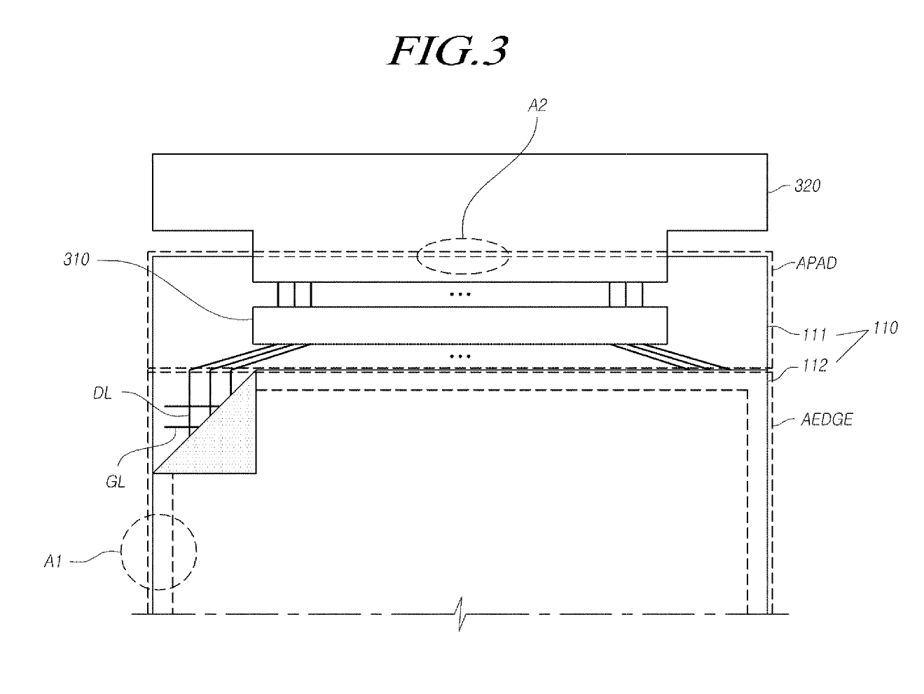

FIGS. 2 and 3 are plane views of a liquid crystal display device 100 according to an exemplary embodiment of the present invention.

Referring to FIGS. 2 and 3, the liquid crystal display device 100 includes the liquid crystal display panel 110, at least one source driver IC 310 included in the data driving unit 120, and a flexible printed circuit (FPC) 320. In the flexible printed circuit 320 (or a printed circuit board connected thereto), the timing controller 140, a power management IC (PMIMC), and the like may be disposed.

The liquid crystal display panel 110 includes a first substrate 111 and a second substrate 112 which are disposed to face each other, a sealant for bonding the substrates 111 and 112, a liquid crystal layer between the bonded substrates 111 and 112, and a flattening layer on the first substrate.

The source driver IC 310 is attached to a pad area Apad on one side of the first substrate 111 and electrically connected with data lines DLs disposed on the first substrate 111.

The flexible printed circuit 320 is attached in part to the pad area Apad on one side of the first substrate 111 and electrically connected with the source driver IC 310.

The liquid crystal display panel 110 further includes the pad area Apad where at least one flexible printed circuit 320 and at least one source driver IC 310 are disposed, and an edge area Aedge including from an edge point to a point apart by a predetermined distance from the edge point in a non-pad area different from the pad area Apad.

Meanwhile, the liquid crystal display device 100 according to the present exemplary embodiments may be classified into the first case CASE 1 and the second case CASE 2 depending on a structure of the flattening layer, which is formed for flattening or insulation after a transistor or the like is formed on the first substrate 111, in the pad area Apad, the edge area Aedge, and the like.

Hereinafter, structures of each of the first case CASE 1 and the second case CASE 2 in a partial area A1 of the edge area Aedge and in a partial area A2 of the pad area Apad will be described.

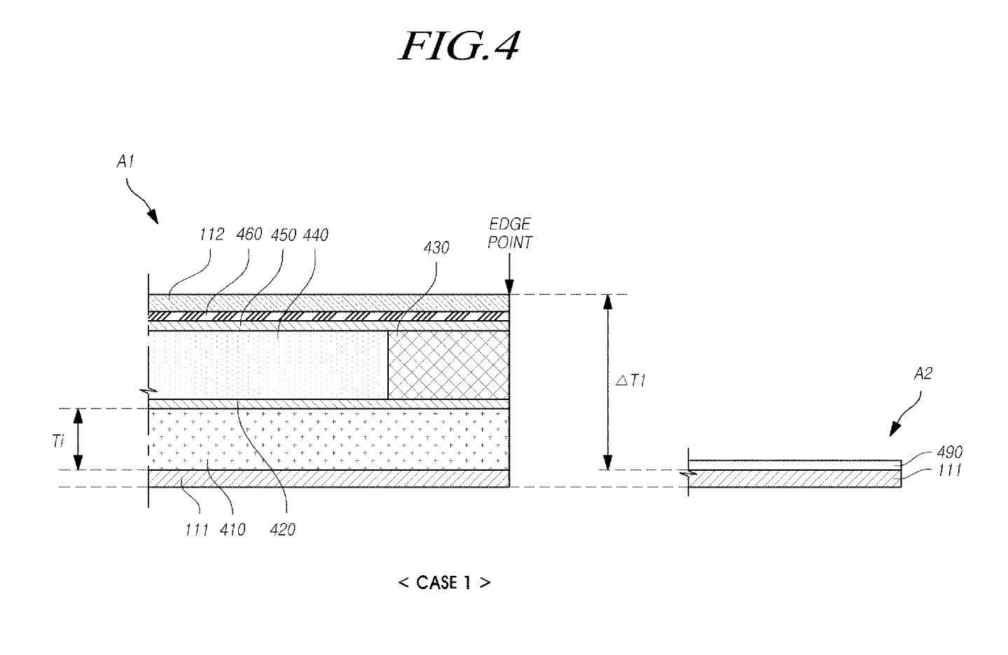

FIG. 4 is a cross-sectional view of the first case CASE 1 of the liquid crystal display device 100 according to an exemplary embodiment of the present invention.

Referring to FIG. 4, in the liquid crystal display device 100 of the first case, a transistor or the like is disposed in each sub-pixel of the first substrate 111 in the area A1 of the edge area Aedge.

A flattening layer 410 is positioned on the first substrate 111. The flattening layer 410 may be a layer formed of photo acryl (PAC). The flattening layer 410 may serve as an insulating layer.

A first polyimide layer 420 is positioned on the flattening layer 410. A surface of the first polyimide layer 420 may be rubbed to serve as an alignment film for aligning liquid crystal molecules in a predetermined direction.

A sealant 430 and a liquid crystal layer 440 are positioned on the first polyimide layer 420. The sealant 430 is provided to bond the first substrate 111 and the second substrate 112 and suppress a leakage of the liquid crystal layer 440, and positioned in an edge portion of the liquid crystal display panel 110. The liquid crystal layer 440 may include a spacer for maintaining a cell gap.

A second polyimide layer 450 is positioned on the sealant 430 and the liquid crystal layer 440. A surface of the second polyimide layer 450 may be also rubbed to serve as an alignment film for aligning liquid crystal molecules in a predetermined direction.

A black matrix 460 and a color filter (not illustrated) are positioned on the second polyimide layer 450. The second substrate 112 is positioned on the black matrix 460.

In the liquid crystal display device 100 of the first case CASE 1, the first substrate 111 and a bonding pad 490 positioned on the first substrate 111 are disposed in the area A2 of the pad area Apad.

The first substrate 111, the flattening layer 410 positioned on the first substrate 111, and the first polyimide layer 420 may be collectively referred to as “TFT (Thin Film Transistor)-array substrate.” Herein, the first substrate 111 may mean a TFT-array substrate.

The second polyimide layer 450, the black matrix 460, the color filter, the second substrate 112, and the like may be collectively referred to as “color filer substrate.” Herein, the second substrate 112 may mean a color filter substrate.

Between the structure of the area A1 in the edge area Aedge and the structure of the area A2 in the pad area Apad of the first case CASE 1, there is a thickness difference (step difference) of “ΔT1” between a thickness of the liquid crystal display panel 110 in the area A1 of the edge area Aedge and a thickness of the liquid crystal display panel 110 in the area A2 of the pad area Apad.

In the first case CASE 1, the flattening layer 410 is present only in the area A1 of the edge area Aedge. Further, the flattening layer 410 is present under an area where the liquid crystal layer 440 is positioned and under an area where the sealant 430 is positioned. As a result, a thickness of the liquid crystal display panel 110 in the area A1 of the edge area Aedge is determined by tallying up all of the thicknesses Ti of the flattening layer 410, a thickness of the sealant 430, and the like.

The flattening layer 410 is one of the thickest layers among various layers constituting the TFT-array substrate. Thus, a thickness of the liquid crystal display panel 110 in the area A1 of the edge area Aedge is considerably greater than a thickness of the liquid crystal display panel 110 in the area A2 of the pad area Apad. That is, in the first case CASE 1 where the flattening layer 410 is present under the area where the liquid crystal layer 440 is positioned and under the area where the sealant 430 is positioned, ΔT1, which is the thickness difference (step difference) between the thickness of the liquid crystal display panel 110 in the area A1 of the edge area Aedge and the thickness of the liquid crystal display panel 110 in the area A2 of the pad area Apad, may be very large.

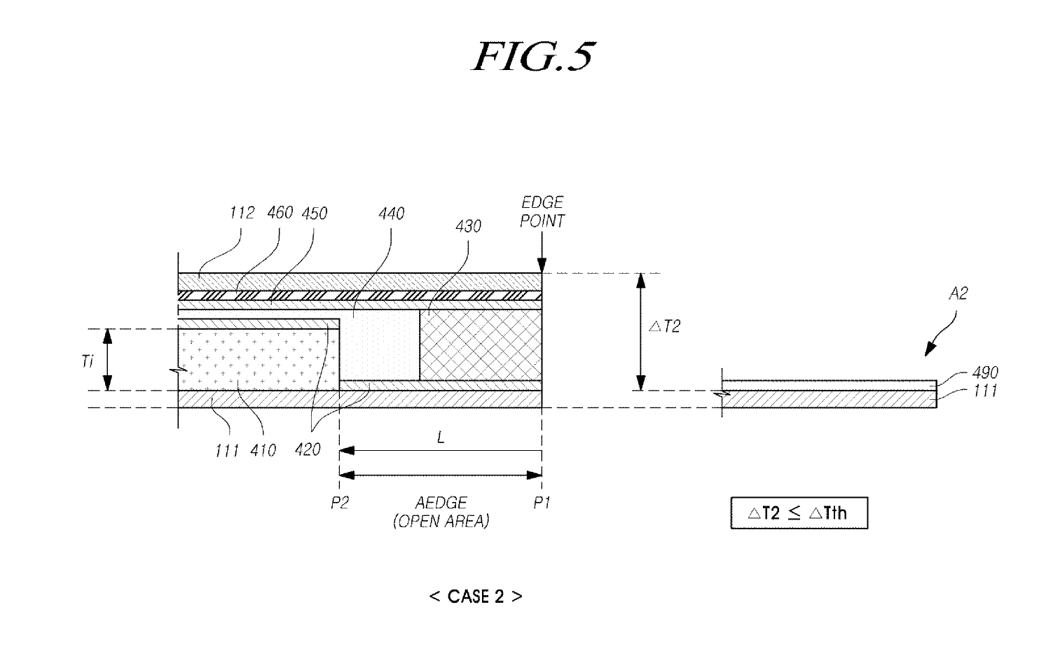

FIG. 5 is a cross-sectional view of a second case CASE 2 of the liquid crystal display device 100 according to an exemplary embodiment of the present invention.

Referring to FIG. 5, in the liquid crystal display device 100 of the second case CASE 2, a transistor or the like is disposed in each sub-pixel of the first substrate 111 in the area A1 of the edge area Aedge.

The flattening layer 410 and the first polyimide layer 420 are positioned on the first substrate 111. In the second case CASE 2, the flattening layer 410 is not present in the entire edge area Aedge but present in a part of the edge area Aedge. Further, the first polyimide layer 420 is present not only on the flattening layer 410 but also on the first substrate 111 in the edge area Aedge. Furthermore, the flattening layer 410 is positioned on the first substrate 111 but not positioned in an area where the sealant 430 is present. That is, in the second case CASE 2, the flattening layer 410 is opened in the area where the sealant 430 is present. That is, the flattening layer 410 is not present between the first substrate 111 and the sealant 430. Further, the flattening layer 410 is positioned in an inward direction from the area where the sealant 430 is present.

The flattening layer 410 may be a layer formed of photo acryl (PAC).

As such, since the flattening layer 410 is formed of photo acryl (PAC), it may be possible to more conveniently and efficiently form a layer for flattening. The flattening layer 410 may serve as an insulating layer.

The sealant 430 and the liquid crystal layer 440 are positioned on the first polyimide layer 420 on the first substrate 111 and on the flattening layer 410. As illustrated in FIG. 5, the sealant 430 may not be present on the first polyimide layer 420 on the flattening layer 410 but may be present on the first polyimide layer 420 on the first substrate 111.

The sealant 430 is provided to bond the first substrate 111 and the second substrate 112 and suppress a leakage of the liquid crystal layer 440, and positioned in the edge portion of the liquid crystal display panel 110.

The second polyimide layer 450 is positioned on the sealant 430 and the liquid crystal layer 440.

The black matrix 460 and the color filter (not illustrated) are positioned on the second polyimide layer 450. The second substrate 112 is positioned on the black matrix 460.

In the liquid crystal display device 100 of the second case CASE 2, the first substrate 111 and the bonding pad 490 positioned on the first substrate 111 are disposed in the area A2 of the pad area Apad.

The first substrate 111, the flattening layer 410 positioned on the first substrate 111, and the first polyimide layer 420 may be collectively referred to as “TFT (Thin Film Transistor)-array substrate”. Herein, the first substrate 111 may mean a TFT-array substrate.

The second polyimide layer 450, the black matrix 460, the color filter, and the second substrate 112 may be collectively referred to as “color filer substrate”. Herein, the second substrate 112 may mean a color filter substrate.

Between the structure of the area A1 in the edge area Aedge and the structure of the area A2 in the pad area Apad of the second case, there is a thickness difference (step difference) of “ΔT2” between a thickness of the liquid crystal display panel 110 in the area A1 of the edge area Aedge and a thickness of the liquid crystal display panel 110 in the area A2 of the pad area Apad.

In the second case CASE 2, the flattening layer 410 is present only in the area A1 of the edge area Aedge and opened in the area where the sealant 430 is positioned. As a result, a thickness of the liquid crystal display panel 110 in the area A1 of the edge area Aedge does not include the thickness Ti of the flattening layer 410.

Considering that the flattening layer 410 is one of the thickest layers among various layers constituting the TFT-array substrate, the thickness of the liquid crystal display panel 110 in the area A1 of the edge area Aedge in the second case CASE 2 becomes considerably smaller than the thickness of the liquid crystal display panel 110 in the area A1 in the edge area Aedge in the first case CASE 1.

As a result, ΔT2, which is the thickness difference between the thickness of the liquid crystal display panel 110 in the area A1 of the edge area Aedge and the thickness of the liquid crystal display panel 110 in the area A2 of the pad area Apad in the second case CASE 2 where the flattening layer 410 is opened in the area where the sealant 430 is positioned, is smaller than ΔT1, which is the thickness difference between the thickness of the liquid crystal display panel 110 in the area A1 of the edge area Aedge and the thickness of the liquid crystal display panel 110 in the area A2 of the pad area Apad in the first case CASE 1 where the flattening layer 410 is also present in the area where the sealant 430 is positioned.

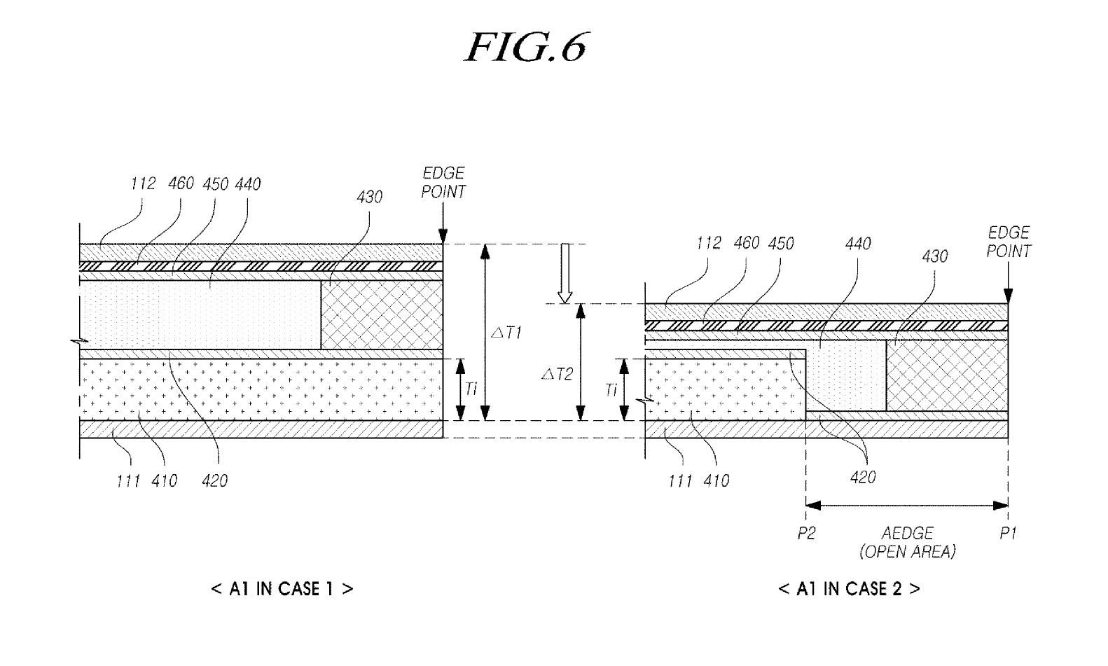

As described above, the step difference ΔT2 in the second case CASE 2 becomes considerably smaller than the step difference ΔT1 in the first case CASE 2, because there is a difference in a position and a structure of the flattening layer 410 in the edge area Aedge as illustrated in FIG. 6. That is, the flattening layer 410 formed to have a very large thickness as compared with the other layers is also present in the area where the sealant 430 is present in the first case CASE 1, but not present in the area where the sealant 430 is present in the second case CASE 2. As a result, ΔT2, which is the thickness difference between the edge area Aedge and the pad area Apad in the second case CASE 2, becomes considerably smaller than ΔT1, which is the thickness difference between the edge area Aedge and the pad area Apad in the first case CASE 1, namely ΔT2<ΔT1.

The liquid crystal display panel 110 of the first case CASE 1 and the liquid crystal display panel 110 of the second case CASE 2 may have different defects during their manufacturing processes due to the different step differences.

For example, when a liquid crystal display device is manufactured, the two substrates are bonded to each other, and then, a scribe process is performed by moving a scribe wheel on the bonded two substrates so as to cut and separate the bonded two substrates into a plurality of liquid crystal display panels 110, each having a unit panel size.

In the first case CASE 1 in which a relatively large step difference exists, when a scribe wheel is moved on the bonded two substrates during a scribe process, possibility of occurrence of damages, such as a crack or the like, in the bonded two substrates (that is, the liquid crystal display panel 110) may be increased, especially at an area where a step starts due to the large step difference ΔT1 between the edge area Aedge and the pad area Apad.

However, in the second case CASE 2 in which a relatively small step difference exists, when a scribe wheel is moved on the bonded two substrates during a scribe process, possibility of occurrence of damages, such as a crack or the like, in the bonded two substrates (that is, the liquid crystal display panel 110) may be decreased at an area where a step starts due to the small step difference ΔT2 between the edge area Aedge and the pad area Apad.

In other words, since the flattening layer 410 formed to have a very large thickness as compared with the other layers is not formed in an area where the sealant 430 is present, it is possible to manufacture the liquid crystal display panel 110 having a small thickness difference between the edge area Aedge and the pad area Apad, and also possible to considerably reduce defect incidence rate during a scribe process due to a small step difference.

As described above, when the liquid crystal display panel 110 is designed to have a structure of the second case CASE 2, damages and defects, such as a crack of the liquid crystal display panel 110 caused by a structural step difference during a scribe process can be reduced. In this regard, the thickness difference ΔT2 of the liquid crystal display panel 110 between the edge area Aedge and the pad area Apad may be set to be equal to or lower than a maximum value ΔTth in a predetermined error tolerance range for a scribe process.

Herein, the predetermined error tolerance range (ΔT (step difference)≦ΔTth) for a scribe process is a tolerance range of a step difference in a panel structure confirmed as having no substantial panel defects, such as cracks or damage, of the liquid crystal display panel 110 or device defects, such as damage or breakdown, of the scribe device (including the scribe wheel) during a scribe process caused by the step difference in the panel structure.

As described above, since the thickness difference ΔT2 between the edge area Aedge and the pad area Apad in the liquid crystal display panel 110 is set within the predetermined error tolerance range for a scribe process, it is possible to reduce possibility of occurrence of damages to the liquid crystal display panel 110 and/or the scribe device (including the scribe wheel) or cracks in the liquid crystal display panel 110 and/or the scribe device (including the scribe wheel) during a scribe process when manufacturing the liquid crystal display panel 110 designed as such.

Meanwhile, the flattening layer 410 may be positioned between a layer where a transistor is positioned on the first substrate 111 and a layer where a pixel electrode electrically connected with a drain or source electrode of the transistor is positioned.

Referring to FIGS. 2, 3 and 5, when the liquid crystal display device 100 has a structure of the second case CASE 2, the “pad area Apad” where the flexible printed circuit 320 and the source driver IC 310 are disposed and the “edge area Aedge” including from an edge point P1 in a non-pad area to a point P2 inwardly apart by a predetermined distance L from the edge point P1 may be a “flattening layer open area” where the flattening layer 410 is opened in the liquid crystal display panel 110.

Herein, the flattening layer open area refers to an area where the flattening layer 410 is opened, that is, an area where the flattening layer 410 is not present.

Meanwhile, the pad area Apad may refer to all areas of the first substrate 111 which are not overlapped with the second substrate 112, as illustrated in FIGS. 2 and 3, or may refer to some areas where the flexible printed circuit 320, the source driver IC 310, connection lines between the source driver IC 310 and data lines, and electrical connection lines between the flexible printed circuit 320 and the source driver IC 310 among all the areas of the first substrate 111 which are not overlapped with the second substrate 112.

As described above, metal is exposed in order to transfer signals among the liquid crystal display panel 110, the flexible printed circuit 320, the source driver IC 310, and various signal wirings (connection lines). As a result, the flattening layer 410 formed to have a very large thickness as compared with the other layers is not formed in the “pad area Apad” where the flattening layer 410 having an insulation function is originally not present and in the “edge area Aedge (P1 to P2)” where the sealant 430 is removed (opened), that is, the flattening layer 410 is not formed in the edge portion of the liquid crystal display panel 110 so as not to be overlapped with the sealant 430, so that it is possible to reduce a step difference in an entire area of the liquid crystal display panel 110. Thus, it is possible to reduce defects such as cracks or damage to the liquid crystal display panel 110 which may be caused by a structural step difference during a scribe process, and also possible to increase the yield and improve the quality of the liquid crystal display panel 110.

Hereinafter, a manufacturing process of the liquid crystal display panels 110 respectively having a structure of the first case CASE 1 and a structure of the second case CASE 2 will be described.

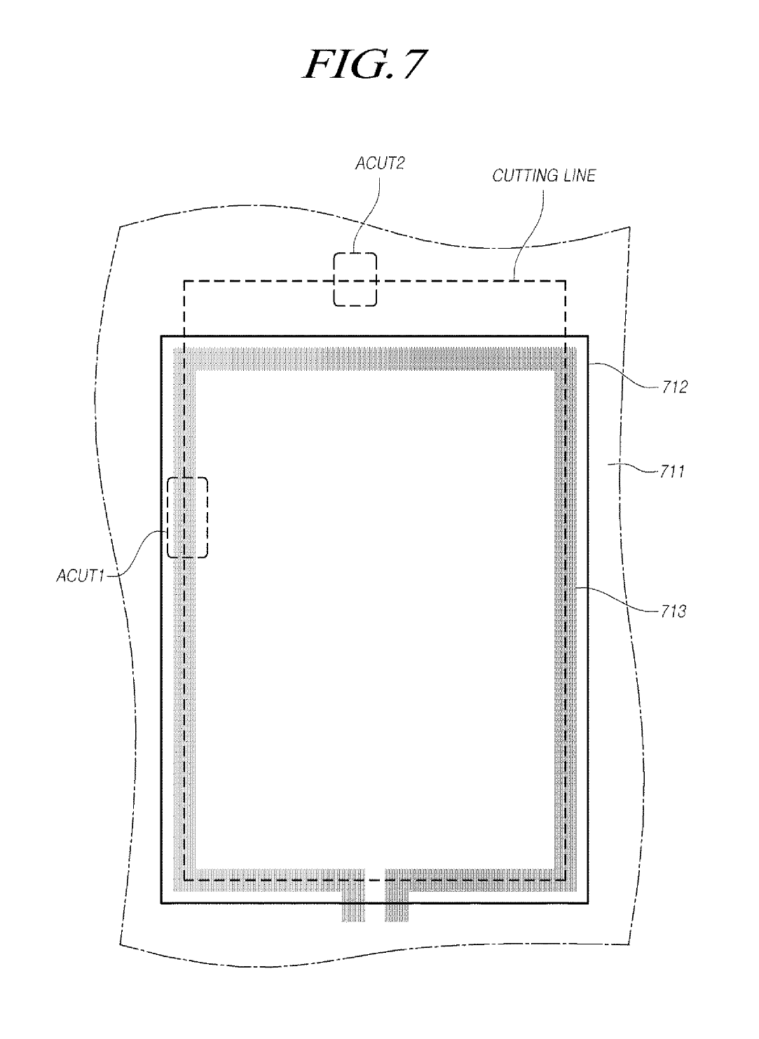

FIG. 7 is a diagram provided for describing a scribe process when manufacturing a liquid crystal display panel 110 according to an exemplary embodiment of the present invention.

Referring to FIG. 7, the transistor, the flattening layer 410, the first polyimide layer 420, and the like are formed on a first mother substrate 711 to serve as the first substrate 111, so that a TFT-array substrate with which many liquid crystal display panels 110 can be manufactured is prepared.

Through another process, the black matrix 460, the color filter, the second polyimide layer 450, and the like are formed on the second substrate 112 or a second mother substrate 712 to serve as the second substrate 112, so that a color filter substrate constituting the liquid crystal display panel 110 is prepared.

A seal pattern 713 for sealing the liquid crystal layer 430 is formed. The seal pattern 713 serves as an adhesive for fixing the TFT-array substrate and the color filter substrate and seals the liquid crystal layer 430 between the two substrates. Further, the seal pattern 713 is formed into a pocket of which one side is opened as a liquid crystal injection opening for injecting a liquid crystal.

The seal pattern 713 may be formed by using a sealant dispensing method, a screen mask method, and the like. As described above, after the seal pattern 713 is formed, the seal pattern 713 is thermally cured, so that the sealant 430 is completely formed.

Then, a scribe process for cutting and separating into unit panels is performed in order to inject a liquid crystal. As an example, the scribe process is divided into a process of forming a cutting line on a glass surface with a diamond pen and a breaking process of separating the glass into unit panels by applying a shock thereto.

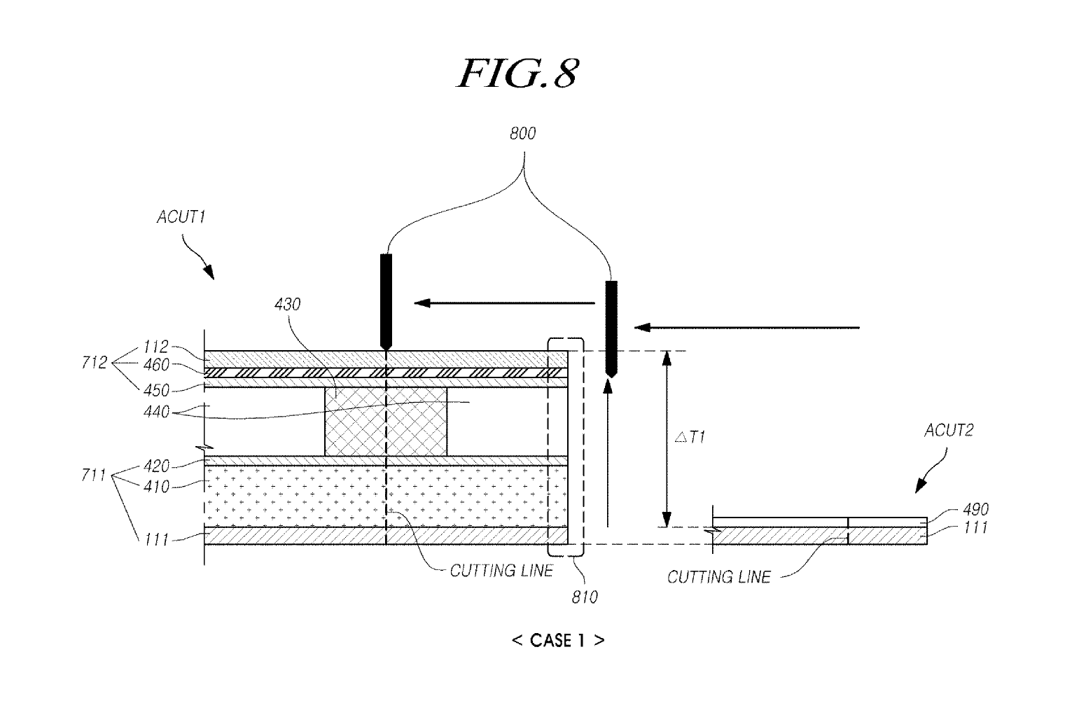

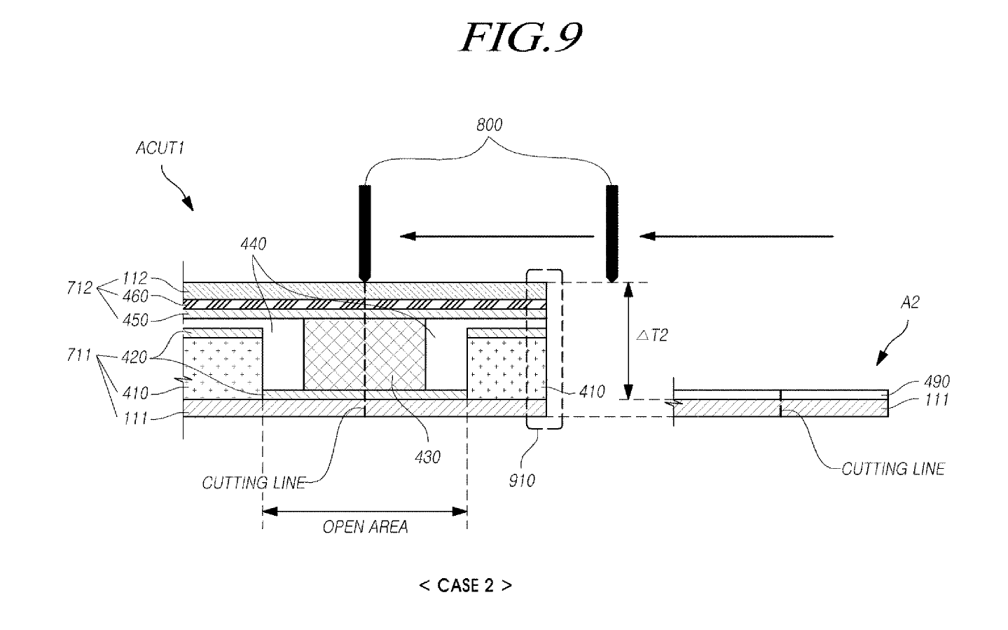

When a liquid crystal panel is designed to have a structure of the first case CASE 1, after a scribe process is performed, an area Acut1 (corresponding to the area A1 in the edge area) and an area Acut2 (corresponding to the area A2 in the pad area) have cross-sectional structures, respectively, as illustrated in FIG. 8. When a liquid crystal panel is designed to have a structure of the second case, after a scribe process is performed, the area Acut1 (corresponding to the area A1 in the edge area) and the area Acut2 (corresponding to the area A2 in the pad area) have cross-sectional structures, respectively, as illustrated in FIG. 9.

FIG. 8 is a cross-sectional view illustrating a scribe process when manufacturing the first case CASE 1 of the liquid crystal display device 100 according to an exemplary embodiment of the present invention. FIG. 9 is a cross-sectional view illustrating a scribe process when manufacturing the second case of the liquid crystal display device according to an exemplary embodiment of the present invention.

Referring to FIG. 8, in the first case CASE 1, the flattening layer 410 is present at a position corresponding to a cutting line (that is, a scribe line), and thus, the first case CASE 1 has a relatively large thickness difference (step difference) ΔT1. As a result, in the first case CASE 1, when a scribe wheel 800 (or scribe device) is moved on the bonded two substrates 711 and 712 during a scribe process for cutting and separating into a plurality of liquid crystal display panels 110, the scribe wheel 800 may collide with an area 810 where a step starts due to the large step difference ΔT1 between the edge area Aedge and the pad area Apad, which may cause damages or cracks in the substrates 711 and 712, thereby leading to a defect in the liquid crystal display panel 110.

Referring to FIG. 9, in the second case CASE 2, the flattening layer 410 is not present at a position corresponding to a cutting line (that is, a scribe line), and thus, the second case CASE 2 has a relatively small thickness difference (step difference) ΔT2. As a result, in the second case CASE 2, when the scribe wheel 800 is moved on the bonded two substrates 711 and 712 during a scribe process for cutting and separating into a plurality of liquid crystal display panels 110, possibility of occurrence of damages or cracks in the substrates 711 and 712 (that is, the liquid crystal panels 110) at an area 910 where a step starts can be reduced due to the relatively small step difference ΔT2 between the edge area Aedge and the pad area Apad.

A mask method may be used to manufacture a structure in which an open area is formed and the flattening layer 410 is positioned on both sides of the sealant 430.

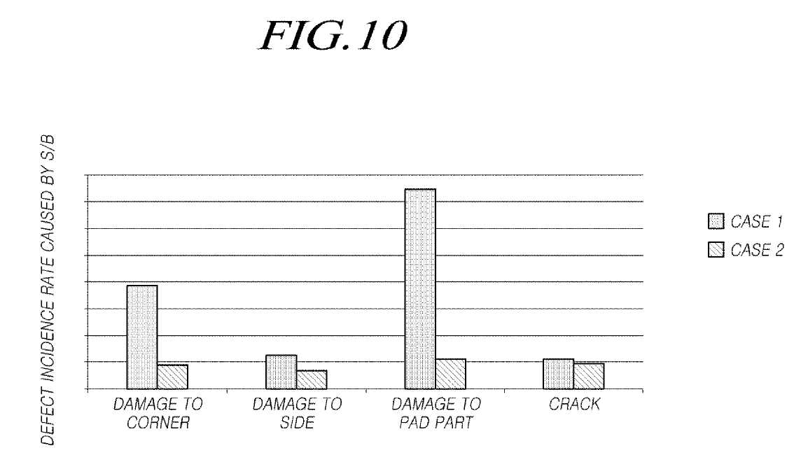

FIG. 10 is a graph showing a defect incidence rate during a scribe process when manufacturing each of the first case CASE 1 and the second case CASE 2 of the liquid crystal display devices according to an exemplary embodiment of the present invention.

Referring to FIG. 10, it can be seen that when the liquid crystal display panel 110 has a structure of the second case CASE 2, a defect incidence rate caused by a scribe (S/B) involved in each of damage to a corner, a side surface, and a pad part and cracks is reduced, as compared with a structure of the first case CASE 1.

According to the exemplary embodiments described above, it is possible to provide the liquid crystal display panel 110 and the liquid crystal display device 100 that have a small step difference. Further, it is possible to provide the liquid crystal display panel 110 and the liquid crystal display device 100 that have a structure capable of reducing possibility of occurrence of defects, such as damages or cracks, during a scribe process.

It will be apparent to those skilled in the art that various modifications and variation can be made in the present invention without departing from the concepts and scope of the invention. Thus, it is intended that the present invention cover the modifications and variations of this invention provided they come within the scope of the appended claims and their equivalents.

### EXPLANATION OF REFERENCE NUMBERS

100: Liquid crystal display device
110: Liquid crystal display panel
120: Data driving unit
130: Gate driving unit
140: Timing controller
410: Flattening layer
430: Sealant

What is claimed is:

1. A display device comprising:
a display panel that includes a first substrate, a second substrate, a sealant for bonding the substrates, and a flattening layer positioned on the first substrate and opened in an area where the sealant is present;
a source driver integrated circuit attached to one side of the first substrate and electrically connected with data lines disposed on the first substrate; and
a flexible printed circuit attached to one side of the first substrate and electrically connected with the source driver integrated circuit.

2. The display device according to claim 1, wherein a pad area where the flexible printed circuit and the source driver integrated circuit are disposed and an edge area including from an edge point in a non-pad area to a point apart by a predetermined distance from the edge point in the display panel is a flattening layer open area where the flattening layer is opened.

3. The display device according to claim 2, wherein a thickness difference between the pad area and the edge area is equal to or lower than a maximum value in an error tolerance range for a scribe process.

4. The display device according to claim 1, wherein the flattening layer is a layer formed of photo acryl (PAC).

5. The display device according to claim 1, wherein the flattening layer is not present between the first substrate and the sealant.

6. The display device according to claim 5, wherein the flattening layer is positioned in an inward direction from the area where the sealant is present.

7. A display panel comprising:
a first substrate;
a second substrate facing the first substrate;
a sealant that bonds the first and second substrates; and
a flattening layer positioned on the first substrate and opened in an area where the sealant is present.

8. The display panel according to claim 7, wherein a pad area where a flexible printed circuit and a source driver integrated circuit are disposed and an edge area including from an edge point in a non-pad area to a point apart by a predetermined distance from the edge point in the display panel is a flattening layer open area where the flattening layer is opened.

9. The display panel according to claim 8, wherein a thickness difference between the pad area and the flattening layer open area is equal to or lower than a maximum value in an error tolerance range for a scribe process.

10. The display panel according to claim 1, wherein the flattening layer is not present between the first substrate and the sealant.

11. A display panel comprising:
a first substrate;
a second substrate facing the first substrate;
a sealant that bonds the first and second substrates; and
a flattening layer positioned on the first substrate and opened in an edge area including from an edge point of the first substrate to a point inwardly apart by a predetermined distance from the edge point.
